(19) United States
(12) Patent Application Publication
(10) Pub. No.: US 2025/0346255 A1
(43) Pub. Date: Nov. 13, 2025

(54) AUTONOMOUS DRIVING GAP ANALYSIS

(71) Applicant: QUALCOMM Incorporated, San Diego, CA (US)

(72) Inventors: Vinay Kumar SENTHIL KUMAR, Philadelphia, PA (US); Pranav DESAI, San Diego, CA (US); Paul Daniel MARTIN, Devon, PA (US)

(21) Appl. No.: 19/068,140

(22) Filed: Mar. 3, 2025

Related U.S. Application Data
(60) Provisional application No. 63/645,645, filed on May 10, 2024.

(51) Int. Cl. B60W 60/00

(52) U.S. Cl. CPC B60W 60/0015; B60W 60/0013; B60W 2554/4049

(57) ABSTRACT

An autonomous driving gap analysis method includes: obtaining indications of a plurality of driving gaps; determining that one or more feasible driving gaps, of the plurality of driving gaps, are feasible for occupation by an ego vehicle; and determining a cost of occupation of only each of the one or more feasible driving gaps.

### CROSS-REFERENCE TO RELATED APPLICATIONS

This application claims the benefit of U.S. Provisional Application No. 63/645,645, filed May 10, 2024, entitled “AUTONOMOUS DRIVING GAP ANALYSIS,” which is assigned to the assignee hereof, and the entire contents of which are hereby incorporated herein by reference for all purposes.

### BACKGROUND

Vehicles are becoming more intelligent as the industry moves towards deploying increasingly sophisticated self-driving technologies that are capable of operating a vehicle with little or no human input, and thus being semi-autonomous or autonomous. Autonomous and semi-autonomous vehicles may be able to detect information about their location and surroundings (e.g., using ultrasound, radar, lidar, an SPS (Satellite Positioning System), and/or an odometer, and/or one or more sensors such as accelerometers, cameras, etc., and/or one or more communication technologies (e.g., for communicating with other vehicles and/or network entities such as roadside units)). Autonomous and semi-autonomous vehicles typically include a control system to interpret information regarding an environment in which the vehicle is disposed to identify hazards and determine a navigation path to follow.

A driver assistance system may mitigate driving risk for a driver of an ego vehicle (i.e., a vehicle configured to perceive the environment of the vehicle) and/or for other road users. Driver assistance systems may include one or more active devices and/or one or more passive devices that can be used to determine the environment of the ego vehicle and, for semi-autonomous vehicles, possibly to notify a driver of a situation that the driver may be able to address. The driver assistance system may be configured to control various aspects of driving safety and/or driver monitoring. For example, a driver assistance system may control a speed of the ego vehicle to maintain at least a desired separation (in distance or time) between the ego vehicle and another vehicle (e.g., as part of an active cruise control system). The driver assistance system may monitor the surroundings of the ego vehicle, e.g., to maintain situational awareness for the ego vehicle. The situational awareness may be used for one or more purposes, e.g., to determine whether and how to change lanes, to notify the driver of issues (e.g., another vehicle being in a blind spot of the driver, another vehicle being on a collision path with the ego vehicle), etc. The situational awareness may include information about the ego vehicle (e.g., speed, location, heading) and/or other vehicles or objects (e.g., location, speed, heading, size, object type, etc.).

A state of an ego vehicle may be used as an input to a number of driver assistance functionalities, such as an Advanced Driver assistance System (ADAS). Downstream driving aids such as an ADAS may be safety critical, and/or may give the driver of the vehicle information and/or control the vehicle in some way.

### SUMMARY

An example autonomous driving gap analysis method includes: obtaining indications of a plurality of driving gaps; determining that one or more feasible driving gaps, of the plurality of driving gaps, are feasible for occupation by an ego vehicle; and determining a cost of occupation of only each of the one or more feasible driving gaps.

An example ego vehicle includes: at least one memory; and at least one processor communicatively coupled to the at least one memory and configured to: obtain indications of a plurality of driving gaps; determine that one or more feasible driving gaps, of the plurality of driving gaps, are feasible for occupation by an ego vehicle; and determine a cost of occupation of only each of the one or more feasible driving gaps.

Another example ego vehicle includes: means for obtaining indications of a plurality of driving gaps; means for determining that one or more feasible driving gaps, of the plurality of driving gaps, are feasible for occupation by an ego vehicle; and means for determining a cost of occupation of only each of the one or more feasible driving gaps.

An example non-transitory, processor-readable storage medium comprising processor-readable instructions to cause at least one processor of an ego vehicle, for autonomous driving gap analysis, to: obtain indications of a plurality of driving gaps; determine that one or more feasible driving gaps, of the plurality of driving gaps, are feasible for occupation by an ego vehicle; and determine a cost of occupation of only each of the one or more feasible driving gaps.

### BRIEF DESCRIPTION OF THE DRAWINGS

FIG. 1 is a top view of an example ego vehicle.

FIG. 2 is a block diagram of components of an example of the ego vehicle shown in FIG. 1.

FIG. 3 is a block diagram of components of an example of the ego vehicle shown in FIG. 2.

FIG. 4 is a top view of an example driving environment.

FIG. 5 is a top view of another example driving environment.

FIG. 6 is a block diagram of data flow through a feasibility unit and a cost unit shown in FIG. 2.

FIG. 7 is a block diagram showing example data flowing through the feasibility unit and the cost unit shown in FIG. 2.

FIG. 8 is a block flow diagram of an example autonomous driving gap analysis method.

### DETAILED DESCRIPTION

Techniques are discussed herein for evaluating driving gaps and selecting a driving gap for an autonomously-driven vehicle to attempt to occupy. For example, identified gaps may be evaluated to determine which, if any, of the identified gaps are feasible for an ego vehicle to occupy based on one or more criteria (e.g., safety criteria, comfort criteria, and a time constraint). Only the driving gap(s) identified as feasible may be evaluated for respective costs (e.g., acceleration, comfort, safety, dynamics) of maneuvering the ego vehicle to occupy each of the feasible driving gap(s). Multiple feasible driving gaps may be ranked based on their respective costs of occupancy, one of the ranked driving gaps (e.g., a lowest-cost driving gap) may be selected, and the ego vehicle controlled to initiate (or continue) maneuvering to occupy the selected driving gap. These are examples, and other examples may be implemented.

Items and/or techniques described herein may provide one or more of the following capabilities, as well as other capabilities not mentioned. Processing efficiency for selecting a driving gap to attempt to occupy may be improved. Model efficiency and/or accuracy for evaluating driving gaps to select a driving gap to occupy may be improved. Complexity of a model for evaluating driving gaps to select a driving gap to occupy may be avoided. Latency in selecting a driving gap to attempt to occupy may be reduced. Other capabilities may be provided and not every implementation according to the disclosure must provide any, let alone all, of the capabilities discussed.

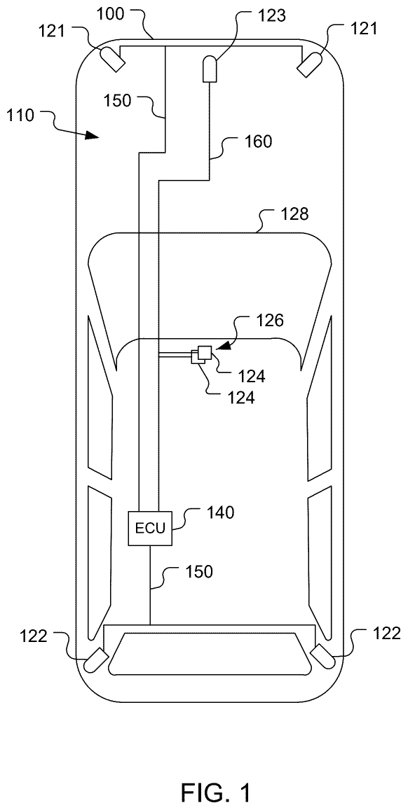

Referring to FIG. 1, an ego vehicle 100 includes an ego vehicle driver assistance system 110. The driver assistance system 110 may include a number of different types of sensors, i.e., heterogeneous sensors, mounted at appropriate positions on the ego vehicle 100. For example, the system 110 may include: a pair of divergent and outwardly directed radar sensors 121 mounted at respective front corners of the vehicle 100, a similar pair of divergent and outwardly directed radar sensors 122 mounted at respective rear corners of the vehicle 100, a forwardly directed LRR sensor 123 (Long-Range Radar) mounted centrally at the front of the vehicle 100, and a pair of generally forwardly directed optical sensors 124 (cameras) forming part of an SVS 126 (Stereo Vision System) which may be mounted, for example, in the region of an upper edge of a windshield 128 of the vehicle 100. Each of the sensors 121, 122 may include an LRR and/or an SRR (Short-Range Radar). The radar sensors 121, 122 and the optical sensors 124 are examples of heterogeneous sensors. The various sensors 121-124 may be operatively connected to a central electronic control system which is typically provided in the form of an ECU 140 (Electronic Control Unit) mounted at a convenient location within the vehicle 100. In the particular arrangement illustrated, the front and rear sensors 121, 122 are connected to the ECU 140 via one or more conventional Controller Area Network (CAN) buses 150, and the LRR sensor 123 and the sensors of the SVS 126 are connected to the ECU 140 via a serial bus 160 (e.g., a faster FlexRay serial bus).

Collectively, and under the control of the ECU 140, the various sensors 121-124 may be used to provide a variety of different types of driver assistance functionalities. For example, the sensors 121-124 and the ECU 140 may provide driving gap identification (e.g., for changing lanes), blind spot monitoring, adaptive cruise control, collision prevention assistance, lane departure protection, and/or rear collision mitigation.

The CAN bus 150 may be treated by the ECU 140 as a sensor that provides ego vehicle parameters to the ECU 140. For example, a GPS (Global Positioning System) module may also be connected to the ECU 140 as a sensor, providing geolocation parameters to the ECU 140.

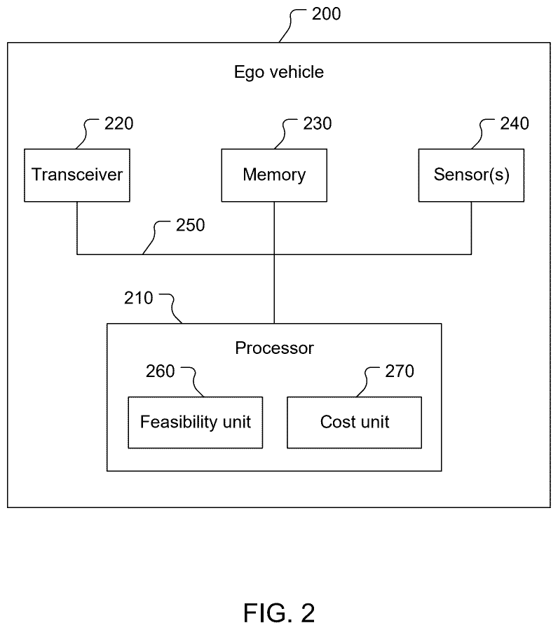

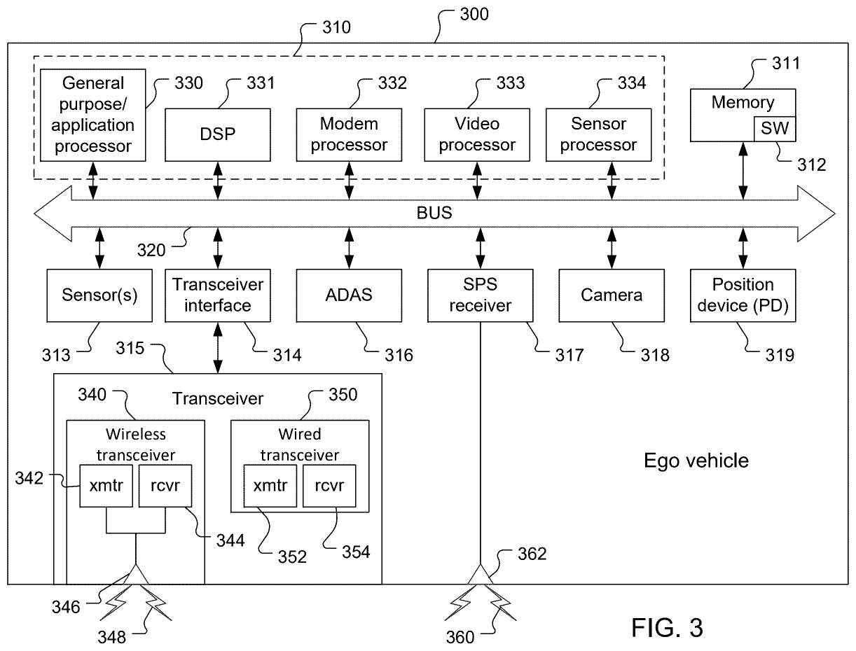

Referring also to FIG. 2, an ego vehicle 200 includes a processor 210 and a memory 230 communicatively coupled to each other by a bus 250. The ego vehicle 200 may also include a transceiver 220 and/or one or more sensors 240. The ego vehicle 200 may include an ADAS (e.g., the ADAS 316 discussed further herein). Even if referred to in the singular, the processor 210 may include one or more processors, the transceiver 220 may include one or more transceivers (e.g., one or more transmitters and/or one or more receivers), and the memory 230 may include one or more memories. The processor 210 may include one or more hardware devices, e.g., a central processing unit (CPU), a microcontroller, an application specific integrated circuit (ASIC), etc. The processor 210 may comprise multiple processors including a general-purpose/application processor, a Digital Signal Processor (DSP), a modem processor, a video processor, and/or a sensor processor. The memory 230 may be a non-transitory, processor-readable storage medium that may include random access memory (RAM), flash memory, disc memory, and/or read-only memory (ROM), etc. The memory 230 may store software which may be processor-readable, processor-executable software code containing instructions that are configured to, when executed, cause the processor 210 to perform various functions described herein. Alternatively, the software may not be directly executable by the processor 210 but may be configured to cause the processor 210, e.g., when compiled and executed, to perform the functions. The transceiver 220 may include one or more components such as a wireless transceiver and possibly a wired transceiver, e.g., as discussed below with respect to FIG. 3.

The description herein may refer to the processor 210 performing a function, but this includes other implementations such as where the processor 210 executes instructions of software (stored in the memory 230) and/or firmware. The description herein may refer to the ego vehicle 200 performing a function as shorthand for one or more appropriate components (e.g., the processor 210 and the memory 230) of the ego vehicle 200 performing the function. The processor 210 (possibly in conjunction with the memory 230 and, as appropriate, the transceiver 220 and/or the sensor(s) 240) may include a feasibility unit 260 and a cost unit 270. The feasibility unit 260 may be configured to perform operations to determine feasibility of gaps for occupation by the ego vehicle 200 (e.g., determine feasibility of navigating to the gaps to occupy the gaps). The cost unit 270 may be configured to perform operations to determine costs of syncing the ego vehicle 200 with (e.g., entering) feasible gaps and selecting a lowest-cost gap to enter. The feasibility unit 260 and the cost unit 270 are discussed further below, and the description may refer to the processor 210 generally, or the ego vehicle 200 generally, as performing any of the functions of the feasibility unit 260 and/or the cost unit 270, with the ego vehicle 200 being configured to perform the function(s).

Referring also to FIG. 3, an ego vehicle 300 (which may be a vehicle user equipment (VUE)) comprises a computing platform including a processor 310, memory 311 including software (SW) 312, one or more sensors 313, a transceiver interface 314 for a transceiver 315 (that includes a wireless transceiver 340 and a wired transceiver 350), an ADAS 316 (Advanced Driver assistance System), a Satellite Positioning System (SPS) receiver 317, a camera 318, and a position device (PD) 319. Even if referred to in the singular, each of the components of the ego vehicle 300 may include one or more of such components, e.g., the processor 310 may include one or more processors, and the memory 311 may include one or more memories. The processor 310, the memory 311, the sensor(s) 313, the transceiver interface 314, the ADAS 316, the SPS receiver 317, the camera 318, and the position device 319 may be communicatively coupled to each other by a bus 320 (which may be configured, e.g., for optical and/or electrical communication). One or more of the shown apparatus may be omitted from the ego vehicle 300. The processor 310 may include one or more hardware devices, e.g., a central processing unit (CPU), a microcontroller, an application specific integrated circuit (ASIC), etc. The processor 310 may comprise multiple processors including a general-purpose/application processor 330, a Digital Signal Processor (DSP) 331, a modem processor 332, a video processor 333, and/or a sensor processor 334. One or more of the processors 330-334 may comprise multiple devices (e.g., multiple processors). For example, the sensor processor 334 may comprise, e.g., processors for RF (radio frequency) sensing (with one or more (cellular) wireless signals transmitted and reflection(s) used to identify, map, and/or track an object), and/or ultrasound, etc. The modem processor 332 may support dual SIM/dual connectivity (or even more SIMs). For example, a SIM (Subscriber Identity Module or Subscriber Identification Module) may be used by an Original Equipment Manufacturer (OEM), and another SIM may be used by an end user of the ego vehicle 300 for connectivity. The memory 311 is a non-transitory storage medium that may include random access memory (RAM), flash memory, disc memory, and/or read-only memory (ROM), etc. The memory 311 may store the software 312 which may be processor-readable, processor-executable software code containing instructions that are configured to, when executed, cause the processor 310 to perform various functions described herein. Alternatively, the software 312 may not be directly executable by the processor 310 but may be configured to cause the processor 310, e.g., when compiled and executed, to perform the functions. The description herein may refer to the processor 310 performing a function, but this includes other implementations such as where the processor 310 executes software and/or firmware. The description herein may refer to the processor 310 performing a function as shorthand for one or more of the processors 330-334 performing the function. The description herein may refer to the ego vehicle 300 performing a function as shorthand for one or more appropriate components of the ego vehicle 300 performing the function. The processor 310 may include a memory with stored instructions in addition to and/or instead of the memory 311. Functionality of the processor 310 (explicitly or implicitly as an example of the processor 210) is discussed more fully below.

The configuration of the ego vehicle 300 shown in FIG. 3 is an example and not limiting of the disclosure, including the claims, and other configurations may be used. For example, an example configuration of the ego vehicle 300 may include one or more of the processors 330-334 of the processor 310, the memory 311, a wireless transceiver, one or more of the sensor(s) 313, the ADAS 316, the SPS receiver 317, the camera 318, and/or the PD 319.

The ego vehicle 300 may include the sensor(s) 313 that may include, for example, one or more of various types of sensors such as one or more inertial sensors, one or more magnetometers, one or more environment sensors, one or more optical sensors, one or more weight sensors, and/or one or more radio frequency (RF) sensors, etc. An inertial measurement unit (IMU) may comprise, for example, one or more accelerometers (e.g., collectively responding to acceleration of the ego vehicle 300 in three dimensions) and/or one or more gyroscopes (e.g., three-dimensional gyroscope(s)). The sensor(s) 313 may include one or more magnetometers (e.g., three-dimensional magnetometer(s)) to determine orientation (e.g., relative to magnetic north and/or true north) that may be used for any of a variety of purposes, e.g., to support one or more compass applications. The environment sensor(s) may comprise, for example, one or more temperature sensors, one or more humidity sensors, one or more barometric pressure sensors, one or more ambient light sensors, one or more camera imagers, and/or one or more microphones, etc. The sensor(s) 313 may generate analog and/or digital signals indications of which may be stored in the memory 311 and processed by the DSP 331 and/or the general-purpose/application processor 330 in support of one or more applications such as, for example, applications directed to positioning and/or navigation operations.

The sensor(s) 313 may be used in relative location measurements, relative location determination, motion determination, etc. Information detected by the sensor(s) 313 may be used for motion detection, relative displacement, dead reckoning, sensor-based location determination, and/or sensor-assisted location determination. The sensor(s) 313 may be useful to determine whether the ego vehicle 300 is fixed (stationary) or mobile. For example, based on the information obtained/measured by the sensor(s) 313, the ego vehicle 300 may determine that the ego vehicle 300 has moved, determine the relative displacement/distance (e.g., via dead reckoning, or sensor-based location determination, or sensor-assisted location determination enabled by the sensor(s) 313), and/or determine present location and/or velocity. In another example, for relative positioning information, the sensors/IMU can be used to determine the angle and/or orientation of the other device with respect to the ego vehicle 300, etc.

The IMU may be configured to provide measurements about a direction of motion and/or a speed of motion of the ego vehicle 300, which may be used in relative location and/or motion determination of the ego vehicle 300 and/or one or more other objects (e.g., vehicles) relative to the ego vehicle 300. For example, one or more accelerometers and/or one or more gyroscopes of the IMU may detect, respectively, a linear acceleration and a speed of rotation of the ego vehicle 300. The linear acceleration and speed of rotation measurements of the ego vehicle 300 may be integrated over time to determine an instantaneous direction of motion as well as a displacement of the ego vehicle 300. The instantaneous direction of motion and the displacement may be integrated to track a location of the ego vehicle 300. For example, a reference location of the ego vehicle 300 may be determined, e.g., using the SPS receiver 317 (and/or by some other means) for a moment in time and measurements from the accelerometer(s) and gyroscope(s) taken after this moment in time may be used in dead reckoning to determine present location of the ego vehicle 300 based on movement (direction and distance) of the ego vehicle 300 relative to the reference location.

The magnetometer(s) may determine magnetic field strengths in different directions which may be used to determine orientation of the ego vehicle 300. For example, the orientation may be used to provide a digital compass for the ego vehicle 300. The magnetometer(s) may include a two-dimensional magnetometer configured to detect and provide indications of magnetic field strength in two orthogonal dimensions. The magnetometer(s) may include a three-dimensional magnetometer configured to detect and provide indications of magnetic field strength in three orthogonal dimensions. The magnetometer(s) may provide means for sensing a magnetic field and providing indications of the magnetic field, e.g., to the processor 310.

The transceiver 315 may include a wireless transceiver 340 and a wired transceiver 350 configured to communicate with other devices through wireless connections and wired connections, respectively. For example, the wireless transceiver 340 may include a wireless transmitter 342 and a wireless receiver 344 coupled to an antenna 346 for transmitting (e.g., on one or more uplink channels and/or one or more sidelink channels) and/or receiving (e.g., on one or more downlink channels and/or one or more sidelink channels) wireless signals 348 and transducing signals from the wireless signals 348 to guided (e.g., wired electrical and/or optical) signals and from guided (e.g., wired electrical and/or optical) signals to the wireless signals 348. The wireless transmitter 342 includes appropriate components (e.g., a power amplifier and a digital-to-analog converter). The wireless receiver 344 includes appropriate components (e.g., one or more amplifiers, one or more frequency filters, and an analog-to-digital converter). The wireless transmitter 342 may include multiple transmitters that may be discrete components or combined/integrated components, and/or the wireless receiver 344 may include multiple receivers that may be discrete components or combined/integrated components. The wireless transceiver 340 may be configured to communicate signals (e.g., with Transmission/Reception Points (TRPs) and/or one or more other devices) according to a variety of radio access technologies (RATs) such as 5G New Radio (NR), GSM (Global System for Mobiles), UMTS (Universal Mobile Telecommunications System), AMPS (Advanced Mobile Phone System), CDMA (Code Division Multiple Access), WCDMA (Wideband CDMA), LTE (Long Term Evolution), LTE Direct (LTE-D), 3GPP LTE-V2X (PC5), IEEE 802.11 (including IEEE 802.11p), WiFi® short-range wireless communication technology, WiFi® Direct (WiFi-D), Bluetooth® short-range wireless communication technology, Zigbee® short-range wireless communication technology, etc. New Radio may use mm-wave frequencies and/or sub-6 GHZ frequencies. The wired transceiver 350 may include a wired transmitter 352 and a wired receiver 354 configured for wired communication, e.g., a network interface that may be utilized to communicate with an NG-RAN (Next Generation-Radio Access Network) to send communications to, and receive communications from, the NG-RAN. The wired transmitter 352 may include multiple transmitters that may be discrete components or combined/integrated components, and/or the wired receiver 354 may include multiple receivers that may be discrete components or combined/integrated components. The wired transceiver 350 may be configured, e.g., for optical communication and/or electrical communication. The transceiver 315 may be communicatively coupled to the transceiver interface 314, e.g., by optical and/or electrical connection. The transceiver interface 314 may be at least partially integrated with the transceiver 315. The wireless transmitter 342, the wireless receiver 344, and/or the antenna 346 may include multiple transmitters, multiple receivers, and/or multiple antennas, respectively, for sending and/or receiving, respectively, appropriate signals.

The ADAS 316 may perform one or more driving operations per one or more commands. For example, the ADAS 316 may include components to control a throttle, brakes, and a steering mechanism of the ego vehicle 300, and may respond to one or more commands, e.g., from the processor 310, to control the throttle, brakes, and/or steering mechanism, e.g., to move the ego vehicle 300 along a trajectory into a driving gap and to sync the ego vehicle 300 in the driving gap (e.g., maintain the vehicle in a moving driving gap).

The SPS receiver 317 (e.g., a Global Positioning System (GPS) receiver) may be capable of receiving and acquiring SPS signals 360 via an SPS antenna 362. The SPS antenna 362 is configured to transduce the SPS signals 360 from wireless signals to wired signals, e.g., electrical or optical signals, and may be integrated with the antenna 346. The SPS receiver 317 may be configured to process, in whole or in part, the acquired SPS signals 360 for estimating a location of the ego vehicle 300. For example, the SPS receiver 317 may be configured to determine location of the ego vehicle 300 by trilateration using the SPS signals 360. The general-purpose/application processor 330, the memory 311, the DSP 331 and/or one or more specialized processors (not shown) may be utilized to process acquired SPS signals, in whole or in part, and/or to calculate an estimated location of the ego vehicle 300, in conjunction with the SPS receiver 317. The memory 311 may store indications (e.g., measurements) of the SPS signals 360 and/or other signals (e.g., signals acquired from the wireless transceiver 340) for use in performing positioning operations. The general-purpose/application processor 330, the DSP 331, and/or one or more specialized processors, and/or the memory 311 may provide or support a location engine for use in processing measurements to estimate a location of the ego vehicle 300.

The ego vehicle 300 may include the camera 318 for capturing still or moving imagery. The camera 318 may comprise, for example, an imaging sensor (e.g., a charge coupled device or a CMOS (Complementary Metal-Oxide Semiconductor) imager), a lens, analog-to-digital circuitry, frame buffers, etc. Additional processing, conditioning, encoding, and/or compression of signals representing captured images may be performed by the general-purpose/application processor 330 and/or the DSP 331. Also or alternatively, the video processor 333 may perform conditioning, encoding, compression, and/or manipulation of signals representing captured images. The video processor 333 may decode/decompress stored image data for presentation on a display device (not shown).

The position device (PD) 319 may be configured to determine a position of the ego vehicle 300, motion of the ego vehicle 300, and/or relative position of the ego vehicle 300, and/or time. For example, the PD 319 may communicate with, and/or include some or all of, the SPS receiver 317. The PD 319 may work in conjunction with the processor 310 and the memory 311 as appropriate to perform at least a portion of one or more positioning methods, although the description herein may refer to the PD 319 being configured to perform, or performing, in accordance with the positioning method(s). The PD 319 may also or alternatively be configured to determine location of the ego vehicle 300 using terrestrial-based signals (e.g., at least some of the wireless signals 348) for trilateration, for assistance with obtaining and using the SPS signals 360, or both. The PD 319 may be configured to determine location of the ego vehicle 300 based on a cell of a serving base station (e.g., a cell center) and/or another technique such as E-CID. The PD 319 may be configured to use one or more images from the camera 318 and image recognition combined with known locations of landmarks (e.g., natural landmarks such as mountains and/or artificial landmarks such as buildings, bridges, streets, etc.) to determine location of the ego vehicle 300. The PD 319 may be configured to use one or more other techniques (e.g., relying on the self-reported location of the ego vehicle 300 (e.g., part of a position beacon of the ego vehicle 300)) for determining the location of the ego vehicle 300, and may use a combination of techniques (e.g., SPS and terrestrial positioning signals) to determine the location of the ego vehicle 300. The PD 319 may include one or more of the sensors 313 (e.g., gyroscope(s), accelerometer(s), magnetometer(s), etc.) that may sense orientation and/or motion of the ego vehicle 300 and provide indications thereof that the processor 310 (e.g., the general-purpose/application processor 330 and/or the DSP 331) may be configured to use to determine motion (e.g., a velocity vector and/or an acceleration vector) of the ego vehicle 300. The PD 319 may be configured to provide indications of uncertainty and/or error in the determined position and/or motion. Functionality of the PD 319 may be provided in a variety of manners and/or configurations, e.g., by the general-purpose/application processor 330, the transceiver 315, the SPS receiver 317, and/or another component of the ego vehicle 300, and may be provided by hardware, software, firmware, or various combinations thereof.

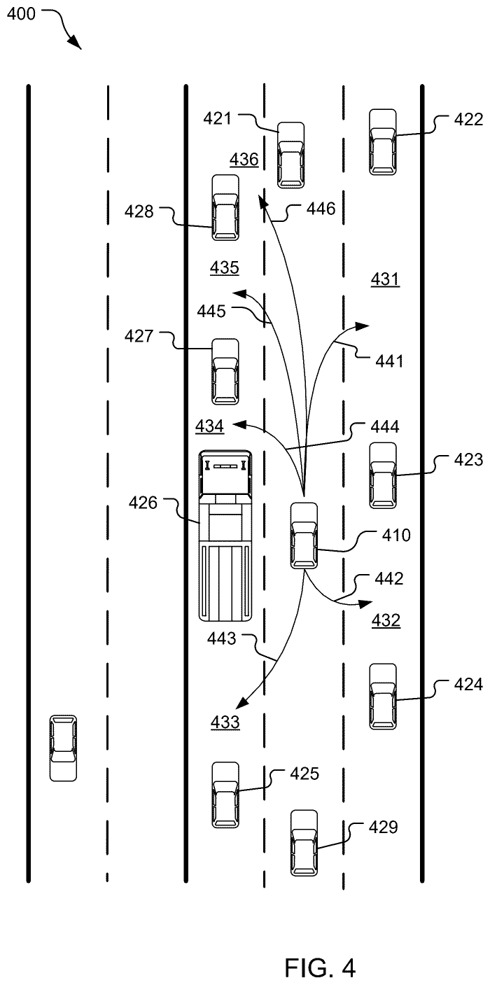

Referring also to FIG. 4, an example driving environment 400 contains several vehicles including an ego vehicle 410 and agent vehicles 421, 422, 423, 424, 425, 426, 427, 428, 429. A vehicle directly in front of the ego vehicle 410, here the agent vehicle 421, is called an ego lead vehicle and a vehicle directly behind the ego vehicle, here the agent vehicle 429, is called an ego follow vehicle. The ego vehicle 410 is an example of the ego vehicle 200 and may want to determine whether the ego vehicle 410 may safely change lanes into a driving gap. A driving gap (which may be referred to herein as a gap) is a volume of open space into which an ego vehicle may be driven. The driving gap may be considered as an area (e.g., ignoring height) or even a linear distance between objects. A driving gap may be defined by two or more objects, e.g., two or more vehicles (a gap lead vehicle and a gap follow vehicle) one of which may be the ego vehicle 410. A driving gap may move over time (e.g., if one or more of the objects delimiting a driving gap moves) such that a particular volume may be a driving gap at one time and may not be a driving gap at a later time. Similarly, a volume may not be a driving gap at one time and may be a driving gap at a later time. The vehicle at the front of a gap may be called the gap lead and the vehicle at the back of a gap may be called the gap follow. As shown in FIG. 4, driving gaps 431, 432, 433, 434, 435, 436 exist between pairs of the agent vehicles 421-428 (here, between the agent vehicles 422, 423 (with the vehicle 422 being the gap lead and the vehicle 423 being the gap follow), between the agent vehicles 423, 424, between the agent vehicles 425, 426, between the agent vehicles 426, 427, between the agent vehicles 427, 428, and between the agent vehicles 428, 421, respectively). The ego vehicle 410 may determine whether the ego vehicle 410 may safely sync with one or more of the driving gaps 431-436, e.g., along respective trajectories 441, 442, 443, 444, 445, 446 (which will change over time with the vehicles 410, 421-428 being in motion).

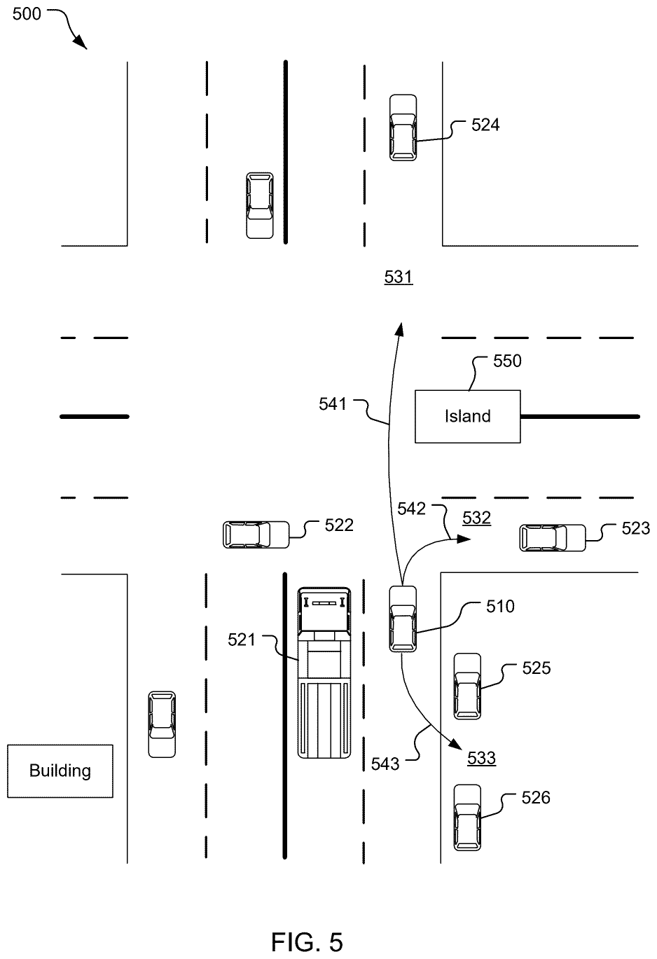

Referring also to FIG. 5, another driving environment 500 is an environment where driving gaps for changing lanes are of interest, but driving gaps for other purposes are possible. The example driving environment 500 contains several vehicles including an ego vehicle 510 and agent vehicles 521, 522, 523, 524, 525, 526. In the environment 500, the ego vehicle 510 may determine whether it is safe and viable to follow trajectories 541, 542, 543 to enter driving gaps 531 (to maintain a lane of travel of the ego vehicle 510 behind the agent vehicle 524 while avoiding a traffic island 550 and the agent vehicles 521, 522), 532 (to turn a corner and merge with the agent vehicles 522, 523), or 533 (to park between the agent vehicles 525, 526). Still other examples of driving gaps are possible.

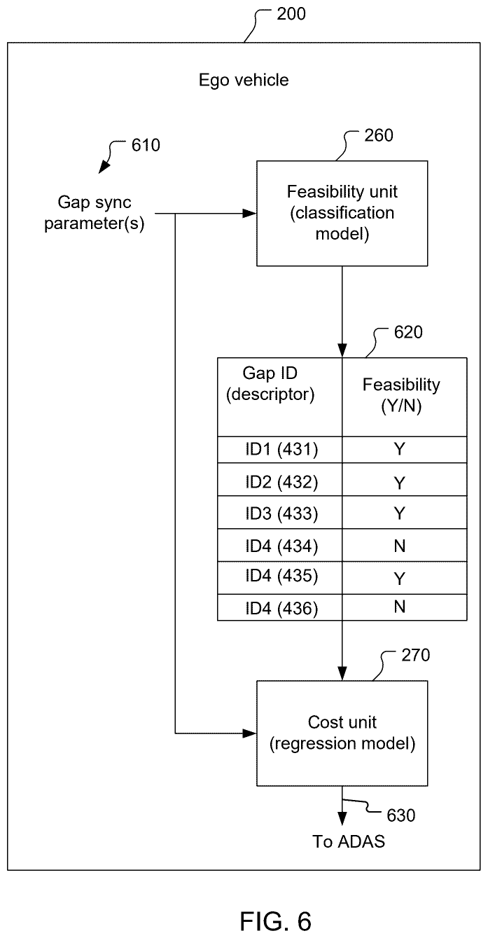

Referring also to FIG. 6, the ego vehicle 200, e.g., the feasibility unit 260 and the cost unit 270, may rank driving gaps for the ego vehicle 200 to occupy. The ego vehicle 200 may rank the driving gaps in a two-stage process, first determining one or more feasible gaps (if any), and second, ranking the feasible driving gaps by cost. This process may avoid performing compute-intensive operations to determine viable trajectories (e.g., by a path planner) for non-feasible gaps, thus conserving processing resources, energy, and time. This process may also or alternatively avoid using a cost of a non-feasible gap to train a (neural network) cost model, thus helping the accuracy and efficiency of the cost model by avoiding erroneous decreases in model accuracy and compute resources expended to evaluate a cost that should not be evaluated (e.g., because the cost is unhelpful to the model or, worse, incorrectly skews the model). A cost of an infeasible gap used to train the cost model may improperly and unnecessarily increase the model complexity. Thus, avoiding this helps reduce complexity of the model, improving run-time efficiency and reducing latency (e.g., for driving decisions).

The feasibility unit 260 and the cost unit 270 may obtain one or more driving gap synchronization parameters 610 for one or more corresponding driving gaps. The gap synchronization parameter(s) 610 comprise information for the ego vehicle 200 to use to enter a driving gap (e.g., to enter in sync with motion of the driving gap). The gap synchronization parameter(s) 610 may be one or more parameters from which a driving gap (e.g., location, size, and motion) may be derived, or may directly indicate the driving gap (e.g., location, size, and motion). The gap synchronization parameter(s) 610 may include gap lead/follow dynamics, ego dynamics, and/or ego lead information, and/or other information. The gap lead/follow dynamics and/or ego lead information may include the velocity, acceleration, and/or station (displacement (distance) relative to a reference point such as the ego vehicle 200) of the gap leader and/or gap follower for a gap (e.g., each identified gap). The station information could be provided as an absolute location that can be translated into a relative displacement knowing the absolute location (e.g., latitude and longitude) of the ego vehicle 200. The gap lead/follow dynamics may include one or more predictions, e.g., a predicted trajectory for one or more of the gap lead, the gap follow, or the gap itself, predicted velocity(ies), predicted accelerations, etc. Predictions may be based, for example, on road information (e.g., applicable (e.g., local and national) traffic control laws and/or signage), traffic information, and/or one or more models of driver behavior, etc. The ego dynamics may include velocity and acceleration, and possibly location, of the ego vehicle 200. Information as to location, size, and motion (e.g., trajectory, speed) of each of one or more driving gaps may be directly indicated or determined, e.g., from sensor information from the sensor(s) 240 and/or from one or more received communications from the transceiver 220. For example, the communication(s) received via the transceiver 220 may include one or more Basic Safety Messages (BSM) received from one or more other vehicles via V2V (Vehicle-to-Vehicle) communication and/or V2X (Vehicle-to-Everything) communication. The communication(s) received from other vehicle(s) may provide information (e.g., agent vehicle location, size, velocity, etc.) that the ego vehicle 200 may use to determine one or more driving gaps. Also or alternatively, the ego vehicle 200 may use sensor information from the sensor(s) 240 (e.g., one or more images, radar information, etc.) to identify one or more driving gaps (e.g., size, location, motion). The gap synchronization parameter(s) 610 provided to (obtained by) the feasibility unit 260 and the cost unit 270 may include, for example, ego vehicle location, agent vehicle(s) location(s), agent vehicle(s) velocity(ies), agent vehicle(s) acceleration(s), predicted trajectory(ies), driving gap location, driving gap motion, and/or scene information (e.g., non-vehicle object location(s)), etc. An indicated object parameter (e.g., agent vehicle location, velocity, acceleration, trajectory) may be an absolute value or a value relative to the ego vehicle 200. Similarly, an indication of a driving gap (e.g., location, velocity, trajectory, acceleration) may be absolute or relative to the ego vehicle 200. The gap synchronization parameter(s) 610 may be provided as an object list in a neural-net-ready format.

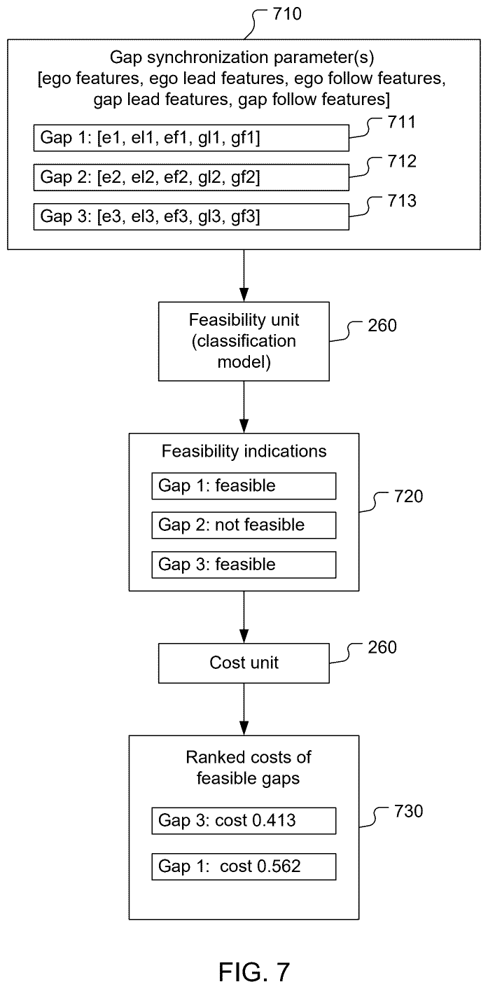

Referring also to FIG. 7, the gap synchronization parameter(s) 610 may be provided as a vector of numbers each corresponding to a respective parameter. In this example, gap synchronization parameters 710 are provided in sets 711, 712, 713 each corresponding to a respective gap, labeled Gap 1, Gap 2, Gap 3. Each of the sets 711-713 provides values of ego features, ego lead features, ego follow features, gap lead features, and gap follow features. Such features may include station, velocity, acceleration, and/or trajectory, etc.

Referring again in particular to FIG. 6, the feasibility unit 260 may be configured to determine whether each of the one or more driving gaps corresponding to the gap synchronization parameter(s) 610 is feasible for the ego vehicle 200 to enter. The feasibility unit 260 may thus determine feasibility for all gaps identified by the gap synchronization parameter(s) 610 to avoid overlooking any gap (e.g., the optimal gap). The feasibility unit 260 may comprise a machine learning classification model, e.g., a neural net classification model. A gap may be feasible to enter if the ego vehicle 200 may be maneuvered into the gap while meeting one or more feasibility criteria. The one or more feasibility criteria may comprise, for example, one or more safety criteria (e.g., avoiding collision, turning within safe operational parameters of the ego vehicle (e.g., to avoid a rollover), etc.), one or more comfort criteria (e.g., acceleration, braking, and/or turning within comfortability threshold(s) (e.g., an induced g-force threshold)), one or more performance criteria (e.g., one or more abilities (e.g., acceleration, braking) of the ego vehicle 200), a time horizon (time limit such as 5 seconds or 8 seconds), etc. The feasibility unit 260 may provide indications 620 of gap feasibilities. The indications 620 may indicate whether each of one or more driving gaps is feasible for the ego vehicle 200 to occupy within the one or more feasibility criteria. In this example, the feasibility is a binary indication of feasible or not feasible. Also or alternatively, a feasibility may be indicated as a probability (e.g., a value between 0 and 1), e.g., with feasible being above a threshold probability near 1, and not feasible being at or below the threshold probability. As shown in the example of FIG. 7, the feasibility unit 260 may process the gap synchronization parameters 710 and provide feasibility indications 720 indicating that Gap 1 and Gap 3 are feasible, and that Gap 2 is infeasible.

The ego vehicle 200, e.g., the cost unit 270, may be configured to have the cost unit 270 determine the gap cost only for gaps identified as being feasible. The cost is a metric of impact on one or more cost criteria (e.g., safety, comfort, time, energy consumption, etc.) for implementing a trajectory to occupy a gap. For example, the indications 620 of gap feasibility may be provided to the cost unit 270 and the cost unit 270 may receive all of the gap synchronization parameter(s) 610 but only determine gap cost for gaps indicated as being feasible. As another example, the indications 620 may be used to filter out the gap synchronization parameter(s) 610 for any gap indicated as not being feasible such that the cost unit 270 only receives the gap synchronization parameter(s) 610 for feasible gaps. The cost unit 270 may comprise a machine learning regression model, e.g., a neural network regression model, that provides a numerical value of the cost for each feasible gap, may rank the feasible gaps according to the cost, and may select a gap based on the ranking. The cost unit 270 may provide an indication 630 of the selected gap, e.g., to an ADAS such as the ADAS 316 for controlling the ego vehicle 200 to occupy (or at least to initiate, or continue, an attempt to occupy) the selected gap. The selected gap may change as conditions change while trying to occupy a gap, e.g., due to reactions of other vehicles to movement of the ego vehicle 200 and/or other changing conditions.

The cost unit 270 may be configured to determine cost in any of a variety of ways. For example, a trajectory may be output for occupying a driving gap and a sum of squares of accelerations for all waypoints in the trajectory may be determined as a cost of the gap corresponding to the trajectory. As another example, a weighted average of gap synchronization costs may be determined as the gap cost. The weight terms may include, for example, safety cost, time cost, comfort cost, lateral cost (side-to-side shifting of the vehicle 200), longitudinal cost (forward-back movement (acceleration/braking) of the vehicle 200), reachability of a gap, violation of time horizon for reaching the gap, velocity cost, etc. The weighting of terms in the weighted average may vary, e.g., depending on a present scenario (e.g., urban road vs. highway), a present maneuver of the ego vehicle 200, etc. The “cost” may be in terms of impact on rider experience (comfort) and/or one or more other criteria (e.g., expense for acceleration, expense for tire wear due to lateral movement, etc.). The cost unit 270 may apply the costs in a regression model to learn composite weighted cost. As the ego vehicle 200 is moved to attempt to occupy a selected driving gap, the feasibility unit 260 and the cost unit 270 will continue (e.g., intermittently such as periodically) to determine the feasibility of gaps and the cost of feasible gaps, and this will be used to train the classification model of the feasibility unit 260 and the regression model of the cost unit 270. The selected gap may have some hysteresis or stickiness such that the selected gap may continue to be selected, for example even if the cost of the selected gap increases and/or the rank of the selected gap decreases.

Referring again in particular to the example shown in FIG. 7, the cost unit 270 may evaluate the costs for the feasible gaps and provide a ranked list 730 of feasible gaps based on the costs. In this example, the cost unit 270 determines the costs for only Gap 1 and Gap 3, which in this example are 0.562 and 0.413 respectively. The cost unit 270 may rank the costs and thus may rank Gap 3 higher than Gap 1 due to Gap 3 having a lower associated cost. The cost unit 270 may select the best (e.g., highest-ranked, lowest-cost) gap to attempt to occupy and indicate to the ADAS 316 the selected gap.

The accuracy of the feasibility determination by the classification model of the feasibility unit 260 may be evaluated in any of a variety of manners. For example, basic accuracy may be evaluated by

$$\frac{1}{N} {\sum }_{i}^{N} 1 ( {y}_{i} = {\hat{y}}_{i} ) \qquad ( 1 )$$

where yᵢ is the predicted cost, ŷᵢ is the ground truth cost, and N is the number of gaps evaluated. As another example, a true positive rate (TPR) may be determined, which is a probability that an actual positive (e.g., feasible) will test positive, with higher TPR being indicative of a more accurate classification model. As another example, a false positive rate (FPR) may be determined, which is a probability that an actual negative (e.g., infeasible) will test positive (e.g., feasible), with a lower FPR being indicative of a more accurate classification model. One or more of these techniques may be used to evaluate how well the classification model is performing, and whether to adjust (and possibly how to adjust) the classification model.

The accuracy of the cost determination by the regression model of the cost unit 270 may be evaluated in any of a variety of manners. For example, a mean absolute error (MAE), a mean squared error (MSE), and/or a mean absolute percentage error (MAPE) may be determined. These evaluations each determine accuracy using a difference between predicted and ground truth values of cost. The MAE is given by

$$\frac{1}{N} {\sum }_{i}^{N} \vert {y}_{i} - {\hat{y}}_{i} \vert \qquad ( 2 )$$

the MSE is given by

$$\frac{1}{N} {\sum }_{i}^{N} {( {y}_{i} - {\hat{y}}_{i} )}^{2} \qquad ( 3 )$$

and the MAPE is given by

$$\frac{1}{N} {\sum }_{i}^{N} \frac{\vert {y}_{i} - {\hat{y}}_{i} \vert}{max ( ε , \vert {y}_{i} \vert )} \qquad ( 4 )$$

where ε is a small positive number to avoid a divide by zero. The MSE may be used to train the regression model and the MAE used to evaluate the accuracy of the regression model. The MAPE may be used to evaluate the accuracy of the regression model, e.g., particularly for different distributions of data, large cost ranges, and/or changing costs. One or more of these techniques may be used to evaluate how well the regression model is performing, and whether to adjust (and possibly how to adjust) the regression model.

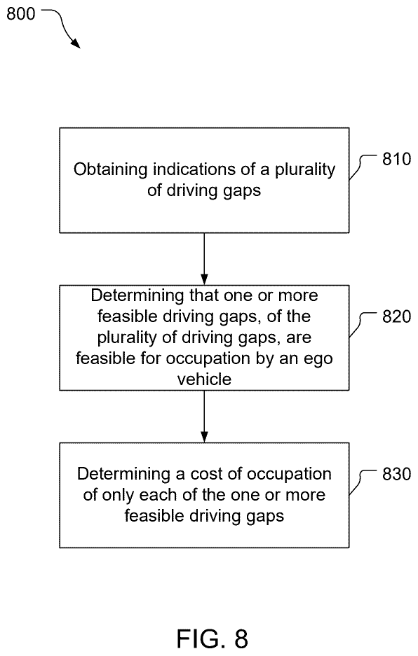

Referring to FIG. 8, with further reference to FIGS. 1-7, an autonomous driving gap analysis method 800 includes the stages shown. The method 800 is, however, an example and not limiting. The method 800 may be altered, e.g., by having one or more stages added, removed, rearranged, combined, performed concurrently, and/or having one or more stages split into multiple stages.

At stage 810, the method 800 includes obtaining indications of a plurality of driving gaps. For example, the processor 210, e.g., the feasibility unit 260, may receive the gap synchronization parameter(s) 610, e.g., from one or more of the sensor(s) 240 and/or from the transceiver 220, and/or from another portion of the processor 210. The processor 210, possibly in combination with the memory 230, possibly in combination with the transceiver 220 (e.g., the wireless receiver 344 and the antenna 346) and/or possibly in combination with the sensor(s) 240 (e.g., one or more cameras, one or more radars, the SPS receiver 317, etc.), may comprise means for obtaining indications of a plurality of driving gaps.

At stage 820, the method 800 includes determining that one or more feasible driving gaps, of the plurality of driving gaps, are feasible for occupation by an ego vehicle. For example, the feasibility unit 260 may apply a classification model to the gap synchronization parameter(s) 610 to determine whether each driving gap corresponding to the gap synchronization parameter(s) 610 is feasible for the ego vehicle 200 to occupy. The processor 210, possibly in combination with the memory 230, may comprise means for determining one or more feasible driving gaps.

At stage 830, the method 800 includes determining a cost of occupation of only each of the one or more feasible driving gaps. For example, the cost unit 270 may apply a regression model to one or more of the gap synchronization parameter(s) 610, for only the driving gaps identified by the feasibility unit 260 as being feasible, to determine the cost of occupying each of the feasible driving gaps. The processor 210, possibly in combination with the memory 230, may comprise means for determining a cost of occupation of only each of the one or more feasible driving gaps.

Implementations of the method 800 may include one or more of the following features. In an example implementation, the method 800 includes initiating movement of the ego vehicle for occupying a selected feasible driving gap of the one or more feasible driving gaps for future occupation by the ego vehicle. For example, the cost unit 270 may send the indication 630 of a lowest-cost feasible gap to an ADAS such as the ADAS 316 so that the ADAS 316 may control one or more appropriate apparatus (e.g., throttle, brakes, steering wheel, etc.) of the ego vehicle 200 to control movement (e.g., initiate or continue movement) toward the selected driving gap. In a further example implementation, the method 800 includes determining the selected feasible driving gap as the feasible driving gap of the one or more feasible driving gaps having a lowest cost of occupation from among the one or more feasible driving gaps. In a further example implementation, determining the cost of occupation of only each of the one or more feasible driving gaps comprises evaluating, by a machine learning regression model, a first set of gap synchronization parameters for each of the one or more feasible driving gaps. The processor 210, possibly in combination with the memory 230, may comprise means for evaluating, by a machine learning regression model, a first set of gap synchronization parameters for each of the one or more feasible driving gaps. In a further example implementation, the second set of gap synchronization parameters comprise object location information, or object motion information, or trajectory information from the ego vehicle to a respective one of the one or more feasible driving gaps, or a time horizon, or ego vehicle movement safety information, or ego vehicle movement comfort information, or any combination of two or more thereof.

Also or alternatively, implementations of the method 800 may include one or more of the following features. In an example implementation, determining the one or more feasible driving gaps comprises evaluating, by a machine learning classification model, a second set of gap synchronization parameters for each of the plurality of driving gaps. The second set of gap synchronization parameters may contain the same parameters as the first set of gap synchronization parameters or may contain one or more different parameters as the first set of gap synchronization parameters and/or one or more fewer parameters than the first set of gap synchronization parameters. In a further example implementation, the second set of gap synchronization parameters comprise object location information, or object motion information, or trajectory information from the ego vehicle to a respective one of the one or more feasible driving gaps, or a time horizon, or ego vehicle movement safety information, or ego vehicle movement comfort information, or any combination of two or more thereof.

### Implementation Examples

Implementation examples are provided in the following numbered clauses.

Clause 1. An autonomous driving gap analysis method comprising:
obtaining indications of a plurality of driving gaps;
determining that one or more feasible driving gaps, of the plurality of driving gaps, are feasible for occupation by an ego vehicle; and
determining a cost of occupation of only each of the one or more feasible driving gaps.

Clause 2. The method of clause 1, further comprising controlling movement of the ego vehicle for occupying a selected feasible driving gap of the one or more feasible driving gaps for future occupation by the ego vehicle.

Clause 3. The method of clause 2, further comprising determining the selected feasible driving gap as the feasible driving gap of the one or more feasible driving gaps having a lowest cost of occupation from among the one or more feasible driving gaps.

Clause 4. The method of clause 3, wherein determining the cost of occupation of only each of the one or more feasible driving gaps comprises evaluating, by a machine learning regression model, a first set of gap synchronization parameters for each of the one or more feasible driving gaps.

Clause 5. The method of clause 4, wherein the first set of gap synchronization parameters comprise object location information, or object motion information, or trajectory information from the ego vehicle to a respective one of the one or more feasible driving gaps, or a time horizon, or ego vehicle movement safety information, or ego vehicle movement comfort information, or any combination of two or more thereof.

Clause 6. The method of clause 1, wherein determining that the one or more feasible driving gaps comprises evaluating, by a machine learning classification model, a second set of gap synchronization parameters for each of the plurality of driving gaps.

Clause 7. The method of clause 6, wherein the second set of gap synchronization parameters comprise object location information, or object motion information, or trajectory information from the ego vehicle to a respective one of the one or more feasible driving gaps, or a time horizon, or ego vehicle movement safety information, or ego vehicle movement comfort information, or any combination of two or more thereof.

Clause 8. An ego vehicle comprising:
at least one memory; and
at least one processor communicatively coupled to the at least one memory and configured to:
   obtain indications of a plurality of driving gaps;
   determine that one or more feasible driving gaps, of the plurality of driving gaps, are feasible for occupation by an ego vehicle; and
   determine a cost of occupation of only each of the one or more feasible driving gaps.

Clause 9. The ego vehicle of clause 8, wherein the at least one processor is configured to control movement of the ego vehicle for occupying a selected feasible driving gap of the one or more feasible driving gaps for future occupation by the ego vehicle.

Clause 10. The ego vehicle of clause 9, wherein the at least one processor is configured to determine the selected feasible driving gap as the feasible driving gap of the one or more feasible driving gaps having a lowest cost of occupation from among the one or more feasible driving gaps.

Clause 11. The ego vehicle of clause 10, wherein to determine the cost of occupation of only each of the one or more feasible driving gaps the at least one processor is configured to evaluate, by a machine learning regression model, a first set of gap synchronization parameters for each of the one or more feasible driving gaps.

Clause 12. The ego vehicle of clause 11, wherein the first set of gap synchronization parameters comprise object location information, or object motion information, or trajectory information from the ego vehicle to a respective one of the one or more feasible driving gaps, or a time horizon, or ego vehicle movement safety information, or ego vehicle movement comfort information, or any combination of two or more thereof.

Clause 13. The ego vehicle of clause 8, wherein to determine that the one or more feasible driving gaps the at least one processor is configured to evaluate, by a machine learning classification model, a second set of gap synchronization parameters for each of the plurality of driving gaps.

Clause 14. The ego vehicle of clause 13, wherein the second set of gap synchronization parameters comprise object location information, or object motion information, or trajectory information from the ego vehicle to a respective one of the one or more feasible driving gaps, or a time horizon, or ego vehicle movement safety information, or ego vehicle movement comfort information, or any combination of two or more thereof.

Clause 15. An ego vehicle comprising:
means for obtaining indications of a plurality of driving gaps;
means for determining that one or more feasible driving gaps, of the plurality of driving gaps, are feasible for occupation by an ego vehicle; and
means for determining a cost of occupation of only each of the one or more feasible driving gaps.

Clause 16. The ego vehicle of clause 15, further comprising means for controlling movement of the ego vehicle for occupying a selected feasible driving gap of the one or more feasible driving gaps for future occupation by the ego vehicle.

Clause 17. The ego vehicle of clause 16, further comprising means for determining the selected feasible driving gap as the feasible driving gap of the one or more feasible driving gaps having a lowest cost of occupation from among the one or more feasible driving gaps.

Clause 18. The ego vehicle of clause 17, wherein the means for determining the cost of occupation of only each of the one or more feasible driving gaps comprise means for evaluating, by a machine learning regression model, a first set of gap synchronization parameters for each of the one or more feasible driving gaps.

Clause 19. The ego vehicle of clause 18, wherein the first set of gap synchronization parameters comprise object location information, or object motion information, or trajectory information from the ego vehicle to a respective one of the one or more feasible driving gaps, or a time horizon, or ego vehicle movement safety information, or ego vehicle movement comfort information, or any combination of two or more thereof.

Clause 20. The ego vehicle of clause 15, wherein the means for determining that the one or more feasible driving gaps comprise means for evaluating, by a machine learning classification model, a second set of gap synchronization parameters for each of the plurality of driving gaps.

Clause 21. The ego vehicle of clause 20, wherein the second set of gap synchronization parameters comprise object location information, or object motion information, or trajectory information from the ego vehicle to a respective one of the one or more feasible driving gaps, or a time horizon, or ego vehicle movement safety information, or ego vehicle movement comfort information, or any combination of two or more thereof.

Clause 22. A non-transitory, processor-readable storage medium comprising processor-readable instructions to cause at least one processor of an ego vehicle, for autonomous driving gap analysis, to:
obtain indications of a plurality of driving gaps;
determine that one or more feasible driving gaps, of the plurality of driving gaps, are feasible for occupation by an ego vehicle; and
determine a cost of occupation of only each of the one or more feasible driving gaps.

Clause 23. The non-transitory, processor-readable storage medium of clause 22, further processor-readable instructions to cause the at least one processor to control movement of the ego vehicle for occupying a selected feasible driving gap of the one or more feasible driving gaps for future occupation by the ego vehicle.

Clause 24. The non-transitory, processor-readable storage medium of clause 23, further comprising processor-readable instructions to cause the at least one processor to determine the selected feasible driving gap as the feasible driving gap of the one or more feasible driving gaps having a lowest cost of occupation from among the one or more feasible driving gaps.

Clause 25. The non-transitory, processor-readable storage medium of clause 24, wherein the processor-readable instructions to cause the at least one processor to determine the cost of occupation of only each of the one or more feasible driving gaps comprise processor-readable instructions to cause the at least one processor to evaluate, by a machine learning regression model, a first set of gap synchronization parameters for each of the one or more feasible driving gaps.

Clause 26. The non-transitory, processor-readable storage medium of clause 25, wherein the first set of gap synchronization parameters comprise object location information, or object motion information, or trajectory information from the ego vehicle to a respective one of the one or more feasible driving gaps, or a time horizon, or ego vehicle movement safety information, or ego vehicle movement comfort information, or any combination of two or more thereof.

Clause 27. The non-transitory, processor-readable storage medium of clause 22, wherein the processor-readable instructions to cause the at least one processor to determine that the one or more feasible driving gaps comprise processor-readable instructions to cause the at least one processor to evaluate, by a machine learning classification model, a second set of gap synchronization parameters for each of the plurality of driving gaps.

Clause 28. The non-transitory, processor-readable storage medium of clause 27, wherein the second set of gap synchronization parameters comprise object location information, or object motion information, or trajectory information from the ego vehicle to a respective one of the one or more feasible driving gaps, or a time horizon, or ego vehicle movement safety information, or ego vehicle movement comfort information, or any combination of two or more thereof.

### Other Considerations

Other examples and implementations are within the scope of the disclosure and appended claims. For example, due to the nature of software and computers, functions described above can be implemented using software executed by a processor, hardware, firmware, hardwiring, or a combination of any of these. Features implementing functions may also be physically located at various positions, including being distributed such that portions of functions are implemented at different physical locations.

As used herein, the singular forms “a,” “an,” and “the” include the plural forms as well, unless the context clearly indicates otherwise. Thus, reference to a device in the singular (e.g., “a device,” “the device”), including in the claims, includes at least one, i.e., one or more, of such devices (e.g., “a processor” includes at least one processor (e.g., one processor, two processors, etc.), “the processor” includes at least one processor, “a memory” includes at least one memory, “the memory” includes at least one memory, etc.). The phrases “at least one” and “one or more” are used interchangeably and such that “at least one” referred-to object and “one or more” referred-to objects include implementations that have one referred-to object and implementations that have multiple referred-to objects. For example, “at least one processor” and “one or more processors” each includes implementations that have one processor and implementations that have multiple processors. Also, a “set” as used herein includes one or more members, and a “subset” contains fewer than all members of the set to which the subset refers.

The terms “comprises,” “comprising,” “includes,” and/or “including,” as used herein, specify the presence of stated features, integers, steps, operations, elements, and/or components, but do not preclude the presence or addition of one or more other features, integers, steps, operations, elements, components, and/or groups thereof.

Also, as used herein, a list of items prefaced by “at least one of” or prefaced by “one or more of” indicates a disjunctive list such that, for example, a list of “at least one of A, B, or C,” or a list of “at least one of A, B, and C,” or a list of “one or more of A, B, or C”, or a list of “one or more of A, B, and C,” or a list of “A or B or C” means A, or B, or C, or AB (A and B), or AC (A and C), or BC (B and C), or ABC (i.e., A and B and C), or combinations with more than one feature (e.g., AA, AAB, ABBC, etc.). Thus, a recitation that an item, e.g., a processor, is configured to perform a function regarding at least one of A or B, or a recitation that an item is configured to perform a function A or a function B, means that the item may be configured to perform the function regarding A, or may be configured to perform the function regarding B, or may be configured to perform the function regarding A and B. For example, a phrase of “a processor configured to measure at least one of A or B” or “a processor configured to measure A or measure B” means that the processor may be configured to measure A (and may or may not be configured to measure B), or may be configured to measure B (and may or may not be configured to measure A), or may be configured to measure A and measure B (and may be configured to select which, or both, of A and B to measure). Similarly, a recitation of a means for measuring at least one of A or B includes means for measuring A (which may or may not be able to measure B), or means for measuring B (and may or may not be configured to measure A), or means for measuring A and B (which may be able to select which, or both, of A and B to measure). As another example, a recitation that an item, e.g., a processor, is configured to at least one of perform function X or perform function Y means that the item may be configured to perform the function X, or may be configured to perform the function Y, or may be configured to perform the function X and to perform the function Y. For example, a phrase of “a processor configured to at least one of measure X or measure Y” means that the processor may be configured to measure X (and may or may not be configured to measure Y), or may be configured to measure Y (and may or may not be configured to measure X), or may be configured to measure X and to measure Y (and may be configured to select which, or both, of X and Y to measure).

As used herein, unless otherwise stated, a statement that a function or operation is “based on” an item or condition means that the function or operation is based on the stated item or condition and may be based on one or more items and/or conditions in addition to the stated item or condition.

Substantial variations may be made in accordance with specific requirements. For example, customized hardware might also be used, and/or particular elements might be implemented in hardware, software (including portable software, such as applets, etc.) executed by a processor, or both. Further, connection to other computing devices such as network input/output devices may be employed. Components, functional or otherwise, shown in the figures and/or discussed herein as being connected or communicating with each other are communicatively coupled unless otherwise noted. That is, they may be directly or indirectly connected to enable communication between them.

The systems and devices discussed above are examples. Various configurations may omit, substitute, or add various procedures or components as appropriate. For instance, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description herein to provide a thorough understanding of example configurations (including implementations). However, configurations may be practiced without these specific details. For example, well-known circuits, processes, algorithms, structures, and techniques have been shown without unnecessary detail in order to avoid obscuring the configurations. The description herein provides example configurations, and does not limit the scope, applicability, or configurations of the claims. Rather, the preceding description of the configurations provides a description for implementing described techniques. Various changes may be made in the function and arrangement of elements.

The terms “processor-readable medium,” “machine-readable medium,” and “computer-readable medium,” as used herein, refer to any medium that participates in providing data that causes a machine to operate in a specific fashion. Using a computing platform, various processor-readable media might be involved in providing instructions/code to processor(s) for execution and/or might be used to store and/or carry such instructions/code (e.g., as signals). In many implementations, a processor-readable medium is a physical and/or tangible storage medium. Such a medium may take many forms, including but not limited to, non-volatile media and volatile media. Non-volatile media include, for example, optical and/or magnetic disks. Volatile media include, without limitation, dynamic memory.

Having described several example configurations, various modifications, alternative constructions, and equivalents may be used. For example, the above elements may be components of a larger system, wherein other rules may take precedence over or otherwise modify the application of the disclosure. Also, a number of operations may be undertaken before, during, or after the above elements are considered. Accordingly, the above description does not bound the scope of the claims.

Unless otherwise indicated, “about” and/or “approximately” as used herein when referring to a measurable value such as an amount, a temporal duration, and the like, encompasses variations of ±20% or ±10%, ±5%, or ±0.1% from the specified value, as appropriate in the context of the systems, devices, circuits, methods, and other implementations described herein. Unless otherwise indicated, “substantially” as used herein when referring to a measurable value such as an amount, a temporal duration, a physical attribute (such as frequency), and the like, also encompasses variations of ±20% or ±10%, ±5%, or ±0.1% from the specified value, as appropriate in the context of the systems, devices, circuits, methods, and other implementations described herein.

A statement that a value exceeds (or is more than or above) a first threshold value is equivalent to a statement that the value meets or exceeds a second threshold value that is slightly greater than the first threshold value, e.g., the second threshold value being one value higher than the first threshold value in the resolution of a computing system. A statement that a value is less than (or is within or below) a first threshold value is equivalent to a statement that the value is less than or equal to a second threshold value that is slightly lower than the first threshold value, e.g., the second threshold value being one value lower than the first threshold value in the resolution of a computing system.

1. An autonomous driving gap analysis method comprising:
obtaining indications of a plurality of driving gaps;
determining that one or more feasible driving gaps, of the plurality of driving gaps, are feasible for occupation by an ego vehicle; and
determining a cost of occupation of only each of the one or more feasible driving gaps.

2. The method of claim 1, further comprising controlling movement of the ego vehicle for occupying a selected feasible driving gap of the one or more feasible driving gaps for future occupation by the ego vehicle.

3. The method of claim 2, further comprising determining the selected feasible driving gap as the feasible driving gap of the one or more feasible driving gaps having a lowest cost of occupation from among the one or more feasible driving gaps.

4. The method of claim 3, wherein determining the cost of occupation of only each of the one or more feasible driving gaps comprises evaluating, by a machine learning regression model, a first set of gap synchronization parameters for each of the one or more feasible driving gaps.

5. The method of claim 4, wherein the first set of gap synchronization parameters comprise object location information, or object motion information, or trajectory information from the ego vehicle to a respective one of the one or more feasible driving gaps, or a time horizon, or ego vehicle movement safety information, or ego vehicle movement comfort information, or any combination of two or more thereof.

6. The method of claim 1, wherein determining that the one or more feasible driving gaps comprises evaluating, by a machine learning classification model, a second set of gap synchronization parameters for each of the plurality of driving gaps.

7. The method of claim 6, wherein the second set of gap synchronization parameters comprise object location information, or object motion information, or trajectory information from the ego vehicle to a respective one of the one or more feasible driving gaps, or a time horizon, or ego vehicle movement safety information, or ego vehicle movement comfort information, or any combination of two or more thereof.

8. An ego vehicle comprising:
at least one memory; and
at least one processor communicatively coupled to the at least one memory and configured to:
obtain indications of a plurality of driving gaps;
determine that one or more feasible driving gaps, of the plurality of driving gaps, are feasible for occupation by an ego vehicle; and
determine a cost of occupation of only each of the one or more feasible driving gaps.

9. The ego vehicle of claim 8, wherein the at least one processor is configured to control movement of the ego vehicle for occupying a selected feasible driving gap of the one or more feasible driving gaps for future occupation by the ego vehicle.

10. The ego vehicle of claim 9, wherein the at least one processor is configured to determine the selected feasible driving gap as the feasible driving gap of the one or more feasible driving gaps having a lowest cost of occupation from among the one or more feasible driving gaps.

11. The ego vehicle of claim 10, wherein to determine the cost of occupation of only each of the one or more feasible driving gaps the at least one processor is configured to evaluate, by a machine learning regression model, a first set of gap synchronization parameters for each of the one or more feasible driving gaps.

12. The ego vehicle of claim 11, wherein the first set of gap synchronization parameters comprise object location information, or object motion information, or trajectory information from the ego vehicle to a respective one of the one or more feasible driving gaps, or a time horizon, or ego vehicle movement safety information, or ego vehicle movement comfort information, or any combination of two or more thereof.

13. The ego vehicle of claim 8, wherein to determine that the one or more feasible driving gaps the at least one processor is configured to evaluate, by a machine learning classification model, a second set of gap synchronization parameters for each of the plurality of driving gaps.

14. The ego vehicle of claim 13, wherein the second set of gap synchronization parameters comprise object location information, or object motion information, or trajectory information from the ego vehicle to a respective one of the one or more feasible driving gaps, or a time horizon, or ego vehicle movement safety information, or ego vehicle movement comfort information, or any combination of two or more thereof.

15. An ego vehicle comprising:
means for obtaining indications of a plurality of driving gaps;
means for determining that one or more feasible driving gaps, of the plurality of driving gaps, are feasible for occupation by an ego vehicle; and
means for determining a cost of occupation of only each of the one or more feasible driving gaps.

16. The ego vehicle of claim 15, further comprising means for controlling movement of the ego vehicle for occupying a selected feasible driving gap of the one or more feasible driving gaps for future occupation by the ego vehicle.

17. The ego vehicle of claim 16, further comprising means for determining the selected feasible driving gap as the feasible driving gap of the one or more feasible driving gaps having a lowest cost of occupation from among the one or more feasible driving gaps.

18. The ego vehicle of claim 17, wherein the means for determining the cost of occupation of only each of the one or more feasible driving gaps comprise means for evaluating, by a machine learning regression model, a first set of gap synchronization parameters for each of the one or more feasible driving gaps.

19. The ego vehicle of claim 18, wherein the first set of gap synchronization parameters comprise object location information, or object motion information, or trajectory information from the ego vehicle to a respective one of the one or more feasible driving gaps, or a time horizon, or ego vehicle movement safety information, or ego vehicle movement comfort information, or any combination of two or more thereof.

20. The ego vehicle of claim 15, wherein the means for determining that the one or more feasible driving gaps comprise means for evaluating, by a machine learning classification model, a second set of gap synchronization parameters for each of the plurality of driving gaps.
